(19) United States
(12) Patent Application Publication
(10) Pub. No.: US 2006/0102398 A1
(43) Pub. Date: May 18, 2006

(54) Fuel cell equipped vehicle

(76) Inventor: Minobu Mizuno, Toyota-shi (JP)

Correspondence Address: KENYON & KENYON LLP, 1500 K STREET N.W., SUITE 700, WASHINGTON, DC, 20005, US

(21) Appl. No.: 10/527,994

(22) PCT Filed: Oct. 2, 2003
(86) PCT No.: PCT/IB03/04338

§ 371 Date: Mar. 21, 2005

(30) Foreign Application Priority Data
Oct. 3, 2002 (JP) 2002-290950

(51) Int. Cl. B60L 8/00

(52) U.S. Cl. 180/65.3

(57) ABSTRACT

In a fuel cell equipped vehicle (10), hydrogen cylinders (18) storing hydrogen gas to be supplied to a fuel cell battery (30), a fuel cell (30), fuel cell accessories (31), a storage battery (40), and a PCU (50) that controls the supply of electric power from the fuel cell (30) and the storage battery (40) to a front wheels-driving electric motor (14) and a rear wheels-driving electric motor (16) are arranged in that order under a floor of a passenger compartment (R1). Therefore, these major component devices do not reduce the spaces of a passenger compartment (R1), a forward compartment (R2), and a rearward compartment (R3). Since the component devices disposed under the floor of the passenger compartment (R1) have relatively great weights, the center of gravity of the vehicle comes to a low position in a central portion of the vehicle, thus achieving good running stability of the vehicle.

### FIELD OF THE INVENTION

The invention relates to a fuel cell equipped vehicle.

### BACKGROUND OF THE INVENTION

Various fuel cell equipped vehicles in which fuel cells are disposed so that a reduction of the compartment space is avoided or minimized have been proposed. For example, Japanese Patent Application Laid-open No. 2001-268720 proposes a vehicle in which a fuel cell battery, a hydrogen storage alloy tank, fuel cell accessories, and a battery unit are horizontally arranged immediately under a compartment floor between the front and rear wheels.

However, Japanese Patent Application Laid-open No. 2001-268720 does not consider where to dispose an electric power control device (also referred to as “power control unit”) that drives a vehicle-driving motor using electric power from the fuel cell battery or electric power from a storage battery, and charges the storage battery using power from the fuel cell battery. Therefore, if the electric power control device is disposed within a compartment of the vehicle, there occur problems. For example, the compartment space of the vehicle is reduced, and the center of gravity of the vehicle cannot be sufficiently lowered.

### DISCLOSURE OF THE INVENTION

It is an object of the invention to provide a fuel cell equipped vehicle having various component devices, including an electronic control unit, in which the compartment space is not sacrificed and the center of gravity of the vehicle is appropriately positioned. Another object is to provide a fuel cell equipped vehicle that allows appropriate connection between component devices.

In accordance with the invention, a fuel cell equipped vehicle includes: a fuel cell that generates electric power through a reaction between a fuel gas and an oxidizing gas; a fuel gas tank that stores the fuel gas to be supplied to the fuel cell; a fuel cell accessory that operates when the fuel cell generates electric power; a storage battery that stores electric energy; and an electric power control unit that controls supply of electric power regarding the fuel cell and the storage battery. The fuel cell, the fuel gas tank, the fuel cell accessory, the storage battery, and the electric power control unit are disposed below a floor of a passenger compartment of the vehicle.

In the above-described fuel cell equipped vehicle of the invention, major component devices, such as the fuel cell, the fuel gas tank, the fuel cell accessory, the storage battery, and the electric power control unit, are disposed below the floor of the passenger compartment in a concentrated fashion. Therefore, the major component devices do not reduce the space of a compartment of the vehicle (e.g., a forward compartment, a passenger compartment, and a rearward compartment). Furthermore, since the component devices disposed below the floor of the passenger compartment have relatively great weights, the center of gravity of the vehicle comes to a low position near the center of the vehicle, thus achieving good running stability of the vehicle.

The fuel cell and the storage battery may be controlled by the electric power control unit so as to supply electric power to a vehicle-driving motor or supply electric power to other vehicle-installed devices (e.g., an air-conditioner, AV devices, navigation devices, illuminators, etc.). The storage battery may be a secondary battery (e.g., nickel metal hydride storage secondary battery, a nickel-cadmium secondary battery, a lithium hydrogen secondary battery, a lead storage battery, etc.), or may be a capacitor or the like that directly stores electric energy.

In a preferred form of the fuel cell equipped vehicle of the invention, the fuel gas tank, the fuel cell, the storage battery, and the electric power control unit may be arranged in that written order in a longitudinal direction relative to the vehicle, below the floor of the passenger compartment. Therefore, since the fuel gas tank and the fuel cell are disposed close to each other, complicated piping for the supply of the fuel gas from the fuel gas tank to the fuel cell can be avoided. Since the fuel cell, the storage battery and the electric power control unit are disposed near to one another, complicated wiring for the electrical connections between these components can be avoided. It is preferable that the fuel gas tank, the fuel cell, the storage battery, and the electric power control unit be arranged in that order from the rear to the front of the vehicle. With this arrangement, the operation of charging the fuel gas tank with the fuel gas can be performed at a rearward site on the vehicle, as in conventional fuel cell equipped vehicles.

In another preferred form of the fuel cell equipped vehicle of the invention, the fuel gas tank, the fuel cell, the electric power control unit, and the storage battery may be arranged in that written order in a longitudinal direction relative to the vehicle, below the floor of the passenger compartment. Therefore, since the fuel gas tank and the fuel cell are disposed close to each other, complicated piping for the supply of the fuel gas from the fuel gas tank to the fuel cell can be avoided. Since the fuel cell, the storage battery and the electric power control unit are disposed near to one another, complicated wiring for the electrical connections between these components can be avoided. It is preferable that the fuel gas tank, the fuel cell, the electric power control unit, and the storage battery be arranged in that order from the rear to the front of the vehicle. With this arrangement, the operation of charging the fuel gas tank with the fuel gas can be performed at a rearward site on the vehicle, as in conventional fuel cell equipped vehicles.

In still another preferred form of the fuel cell equipped vehicle of the invention, the fuel cell accessory may be disposed at one or both of a right side and a left side of the fuel cell. Therefore, since the fuel cell accessory that operates at the time of power generation of the fuel cell is disposed close to the fuel cell, complicated piping or the like for the connection between the fuel cell and the accessory can be avoided. Examples of the fuel cell accessory include an oxidizing gas supplying device that supplies the oxidizing gas to the fuel cell, a fuel gas supplying device that supplies the fuel gas to the fuel cell, a mass flow controller that adjusts the pressure and the amount of flow of the fuel gas to be supplied to the fuel cell, a fuel gas circulating device that supplies the unreacted fuel gas discharged from the fuel cell back to the fuel cell, a cooling water circulating device that circulates cooling water through the fuel cell in order to cool the fuel cell, etc.

In a preferred form of the fuel cell equipped vehicle of the invention, the devices disposed below the floor of the passenger compartment may be disposed so that upper surfaces of the devices are at substantially equal heights. This arrangement facilitates a flat design of the floor face of the passenger compartment.

In a preferred form of the fuel cell equipped vehicle of the invention, the devices disposed below the floor of the passenger compartment may be mounted on an upper portion of a generally flat portion of a body frame of the vehicle which extends between a front wheel and a rear wheel. This arrangement allows the devices to be comparatively easily mounted by utilizing the body frame.

In a preferred form of the fuel cell equipped vehicle of the invention, the devices disposed below the floor of the passenger compartment may be disposed by utilizing a space formed between a right-side frame of a body frame of the vehicle which extends in a longitudinal direction relative to the vehicle in a right-side portion of the vehicle and a left-side frame of the body frame which extends in the longitudinal direction relative to the vehicle in a left-side portion of the vehicle. This arrangement allows the thickness of each device to be increased by an amount corresponding to the height of the body frame, in comparison with the arrangement in which the devices are mounted on top of the body frame.

In a preferred form of the invention, the fuel cell equipped vehicle may further include a radiator that radiates heat from a cooling water for cooling the fuel cell, and that is disposed on a portion of a body frame of the vehicle which extends between a central portion of the body frame and a forward portion of the body frame. This arrangement will increase the space of a forward compartment of the vehicle.

In a preferred form of the above-described fuel cell equipped vehicle, the radiator may be disposed so as to lie between two frame rails of the body frame. This arrangement will increase the space of the forward compartment of the vehicle.

In a preferred form of the invention, the fuel cell equipped vehicle may further include at least one of a front wheel-driving electric motor and a rear wheel-driving electric motor. In this construction, the electric power control unit controls supply of electric power from the fuel cell and the storage battery to the at least one of the front wheel-driving electric motor and the rear wheel-driving electric motor. Therefore, the invention can be appropriately applied to a vehicle that runs by supplying electric power from a fuel cell or a storage battery to an electric motor.

In a preferred form of the invention, the fuel cell equipped vehicle may further include a gas pipe that supplies the fuel gas from the fuel gas tank to the fuel cell, and an electrical wire that conducts electric power from the fuel cell and the storage battery to the electric power control unit. In this construction, the gas pipe is provided in one of a right-side portion and a left-side portion of the vehicle, and the electrical wire is provided in another one of the right-side portion and the left-side portion of the vehicle. This arrangement is favorable for maintenance operations and the like since the gas pipe and the electric wire are laid separately in the right-side portion and the left-side portion of the vehicle.

In a preferred form of the invention, the fuel cell equipped vehicle may further include a coolant circulator device that circulates a coolant for cooling the fuel cell. In this construction, a coolant circulation path of the coolant circulator device and the gas pipe are provided in one of the right-side portion and the left-side portion of the vehicle, and the electrical wire is provided in another one of the right-side portion and the left-side portion of the vehicle. This arrangement is favorable for maintenance operations and the like since the gas pipe and the coolant circulation path are laid apart from the electric wire.

### BRIEF DESCRIPTION OF THE DRAWINGS

FIG. 1 is a plan view of a fuel cell equipped vehicle in accordance with an embodiment of the invention;

FIG. 2 is a schematic sectional view of the fuel cell equipped vehicle of the embodiment;

FIG. 3 is a perspective view of various component devices arranged on a body frame; and

FIG. 4 is a block diagram of the fuel cell equipped vehicle of the embodiment.

### DETAILED DESCRIPTION OF PREFERRED EMBODIMENTS

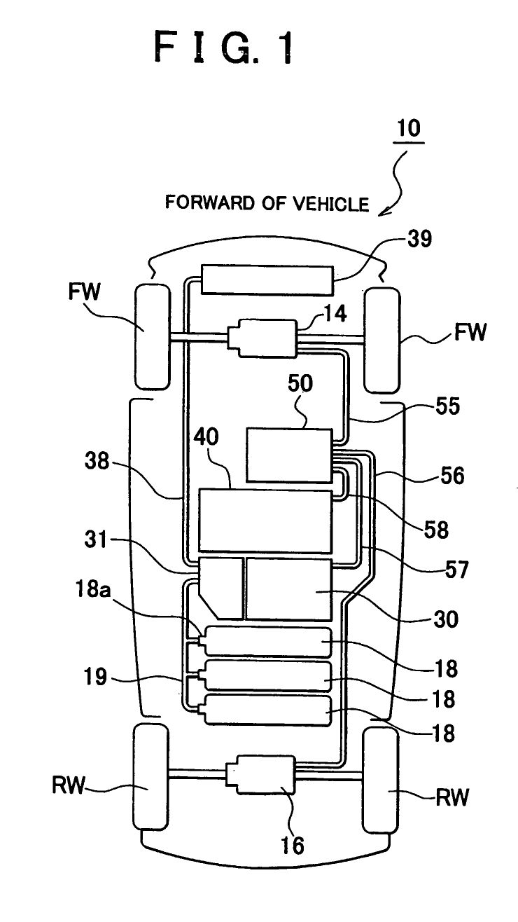

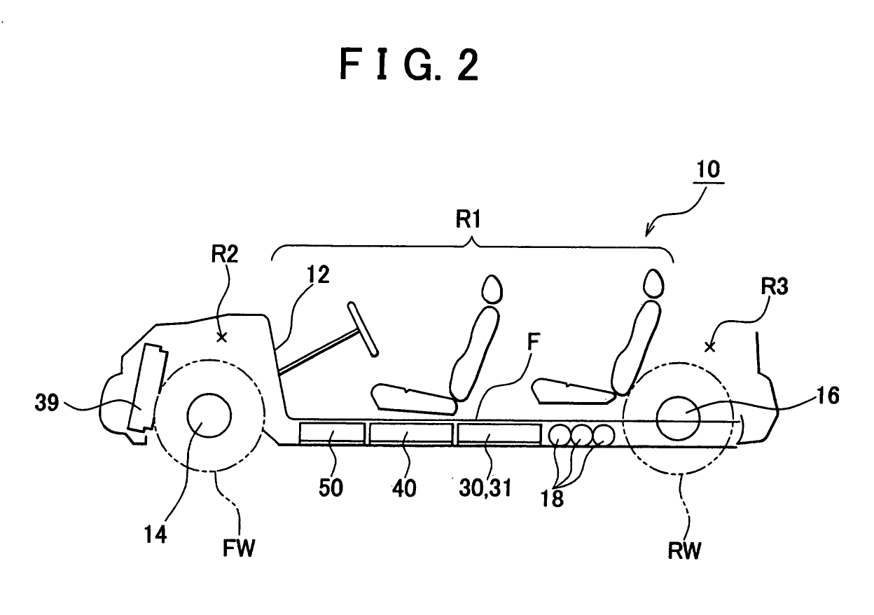

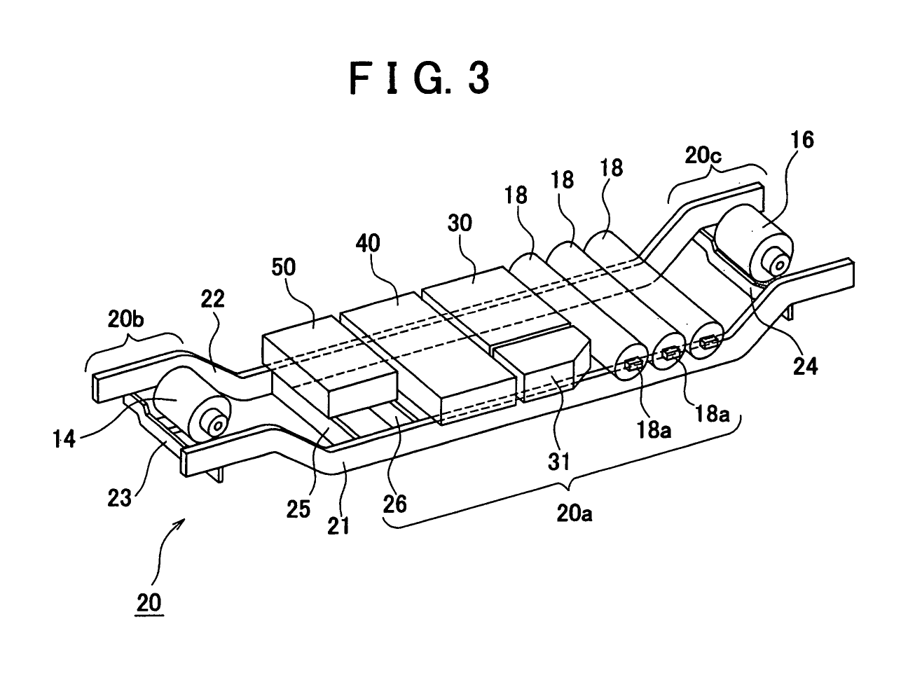

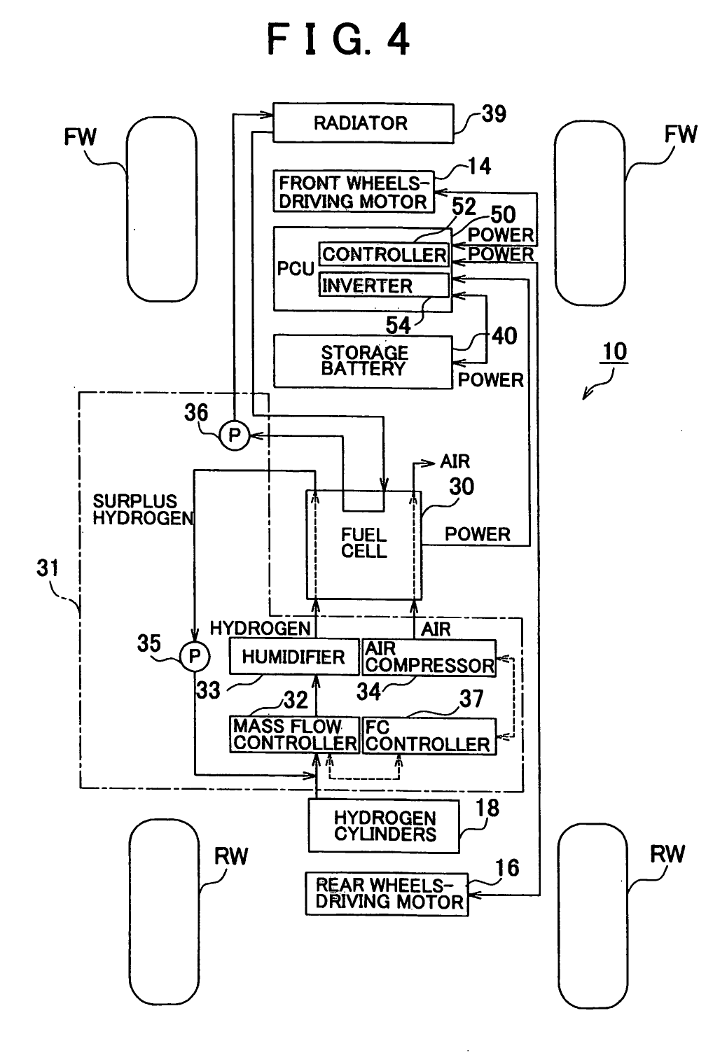

To make the invention more apparent and clear, preferred embodiments of the invention will be described with reference to the accompanying drawings. FIG. 1 is a schematic plan view of a fuel cell equipped vehicle in accordance with an embodiment of the invention. FIG. 2 is a schematic sectional view of the fuel cell equipped vehicle. FIG. 3 is a perspective view of various component devices arranged on a body frame. FIG. 4 is a block diagram of the fuel cell equipped vehicle.

A fuel cell equipped vehicle 10 of the embodiment, as shown in FIG. 2, has a passenger compartment R1 in which a driver seat, a passenger or navigator seat and rear seats are disposed, a forward compartment R2 provided near front wheels and separated from the passenger compartment R1 by a dashboard 12, and a rearward compartment R3 provided near rear wheels for use as a luggage compartment or the like.

The fuel cell equipped vehicle 10 has a body frame 20 as shown in FIG. 3. The body frame 20 is substantially made up of a pair of frame rails 21, 22 spaced from each other in a transverse direction relative to the vehicle and extending in a longitudinal direction relative to the vehicle, a front cross member 23 connecting front portions of the two frame rails 21, 22, a rear cross member 24 connecting rear portions of the frame rails 21, 22, and center cross members 25, 26 connecting central portions of the frame rails 21, 22. A central portion 20a of the body frame 20 which extends between the front wheels FW and the rear wheals RW is generally flat. A forward portion 20b of the body frame 20 is curved upward so as to avoid interference with the front wheels FW. A rearward portion 20c of the body frame 20 is curved upward so as to avoid interference with the rear wheels RW. A front wheels-driving electric motor 14 is mounted on the front cross member 23, and a rear wheels driving electric motor 16 is mounted on the rear cross member 24. Hydrogen cylinders 18, a fuel cell battery 30, a storage battery 40, and a power control unit (hereinafter, referred to as “PCU”) 50 are disposed in that order in the direction from the rear to the front of the vehicle, within a space between the flat central portion 20a of the body frame 20 and a flat floor face F of the passenger compartment R1. The hydrogen cylinders 18 and the storage battery 40, each extending across upper surfaces of the two frame rails 21, 22, are fixed to the body frame 20 via brackets (not shown). The PCU 50 is laid on or over upper surfaces of the center cross members 25, 26, and is fixed to the body frame 20 via a bracket (not shown). The fuel cell battery 30 is laid together with fuel cell battery accessories 31 on or over upper surfaces of cross members (not shown), and is fixed to the body frame 20 via a bracket (not shown).

The front wheels-driving electric motor 14 is one of drive power sources of the fuel cell equipped vehicle 10. The electric motor 14 is supplied with three-phase alternating current converted by the PCU 50 from direct current output from the fuel cell battery 30 or the storage battery 40. With the electric power thus supplied, the electric motor 14 generates rotating drive force to rotate the front wheels FW. The rear wheels-driving electric motor 16, being another drive power source of the fuel cell equipped vehicle 10, is supplied with three-phase alternating current converted by the PCU 50 from direct current output from the fuel cell battery 30 or the storage battery 40. With the electric power thus supplied, the electric motor 16 generates rotating drive force to rotate the rear wheels RW.

The hydrogen cylinders 18 are vessels storing a high-pressure compressed hydrogen gas as a fuel gas to be supplied to the fuel cell battery 30. In this embodiment, a plurality of hydrogen cylinders 18 are laid across the gap between the two frame rails 21, 22, in a rearward portion of the flat central portion 20a of the body frame 20, and are fixed to the body frame 20 via steel bands (not shown). Each hydrogen cylinder 18 has an open-close valve 18a that is used to supply hydrogen gas to the fuel cell battery 30 or charge the cylinder with hydrogen gas when the amount of hydrogen gas remaining becomes small. Each hydrogen cylinder 18 is laid so that the open-close valve 18a faces the left side of the vehicle.

The fuel cell battery 30 is a well-known solid polymer electrolyte type fuel cell battery, and has a stack structure in which a plurality of unit cells, i.e., constitutional units, are stacked. The fuel cell battery 30 functions as an electric power source of high voltage (several hundred V). Each unit cell of the fuel cell battery 30 generates an electromotive force as follows. As indicated in FIG. 4, hydrogen gas (fuel gas) from the hydrogen cylinder 18 is subjected to adjustment in pressure and amount of flow by a mass flow controller 32, and is humidified by a humidifier 33, and then is supplied to an anode of each unit cell. A cathode of each unit cell is supplied with a pressure-regulated compressed air (oxidizing gas) from an air compressor 34. As a result, predetermined electrochemical reactions progress in each unit cell to generate electromotive force. More specifically, hydrogen separates into protons and electrons on the anode. The protons generated on the anode migrate through a solid polymer electrolyte membrane, and reach the cathode while the electrons generated on the anode reach the cathode through a wire connected via a load. On the cathode, the protons and the electrons combine with oxygen to form water. These electrochemical reactions progress to generate electromotive force.

The fuel cell battery accessories 31 include the mass flow controller 32, the humidifier 33, and the air compressor 34 mentioned above, and further include a hydrogen gas circulating pump 35 for supplying unreacted hydrogen gas discharged from the fuel cell battery 30 back to the fuel cell battery 30, a water pump 36 that circulates fuel cell battery-cooling water between the fuel cell battery 30 and a heat radiator 39, an FC controller 37 (FC is an abbreviation of fuel cell) that outputs a control signal for controlling the amounts of gas supplied to the fuel cell battery 30 to the mass flow controller 32 and the air compressor 34 on the basis of values detected by various sensors (not shown), such as the position of an accelerator pedal detected by an accelerator pedal sensor (not shown), etc. The accessories are contained in an accessory box disposed on the left side of the fuel cell battery 30. A gas pipe 19 (see FIG. 1) connecting the hydrogen cylinders 18 and the mass flow controller 32, and a cooling water circulation path 38 (see FIG. 1) connecting the fuel cell battery 30 and the radiator 39 are laid in a left side portion of the vehicle in a concentrated manner. As for the power supply to fuel cell battery accessories 31, a low-voltage battery (not shown), for example, a 12-V battery, may be used, or high-voltage power from the fuel cell battery 30 or the storage battery 40 may be converted to a low-voltage power by the PCU 50. Such a low-voltage battery, if employed, may be disposed in a space portion on the left side of the PCU 50 in the space between the body frame 20 and the flat floor face F of the passenger compartment R1.

The storage battery 40 has a structure in which a plurality of well-known nickel metal hydride storage batteries are connected in series, and functions as an electric power source of high voltage (several hundred V). The storage battery 40 is controlled by the PCU 50 so as to drive the wheels-driving electric motors 14, 16 at the time of launching the vehicle, or recover regenerative electric power during a deceleration regeneration operation, or supply assist power to the electric motors 14, 16 during acceleration of the vehicle, or be charged via the fuel cell battery 30 in accordance with the load. The storage battery 40 is not limited to a nickel metal hydride storage battery, but may be any type battery as long as the battery is capable of charge-discharge operations. For example, the storage battery 40 may be a nickel-cadmium storage battery, a lithium hydrogen storage battery, a lead storage battery, or the like, and may also be a capacitor.

The PCU 50 includes a controller portion 52 formed as a logic circuit having a microcomputer as a central component, and an inverter portion 54 for conversion between the high-voltage direct current of the fuel cell battery 30 or the storage battery 40 and the alternating current of the wheels-driving electric motors 14, 16. Electric breakers (not shown) are disposed between the fuel cell battery 30 and the PCU 50, and between the storage battery 40 and the PCU 50. The controller portion 52 of the PCU 50 controls the operations of the inverter portion 54 and each electric breaker in accordance with the loads on the wheels-driving electric motors 14, 16 and the amount of electricity stored in the storage battery 40 so as to supply electric power generated by the fuel cell battery 30 to the wheels-driving electric motors 14, 16 or the storage battery 40, or supply electric power stored in the storage battery 40 to the wheels-driving electric motors 14, 16. For example, when the load on the wheels-driving electric motors 14, 16 is great during vehicle acceleration or the like, the wheels-driving electric motors 14, 16 are supplied with both power generated by the fuel cell battery 30 and power stored in the storage battery 40. During deceleration or braking or the like, regenerative electric power obtained from the wheels-driving electric motors 14, 16 is supplied to the storage battery 40. The electric breakers may be disposed within the case of the fuel cell battery 30 and the case of the storage battery 40, or may also be disposed within the case of the PCU 50.

As indicated in FIG. 1, electric cables 55, 56 connecting the PCU 50 and the wheels-driving electric motors 14, 16, an electric cable 57 connecting the PCU 50 and the fuel cell battery 30, and an electric cable 58 connecting the PCU 50 and the storage battery 40 are laid in a right-side portion of the vehicle.

In the fuel cell equipped vehicle 10 of the embodiment constructed as described above, major component devices, such as the hydrogen cylinders 18, the fuel cell battery 30, the fuel cell battery accessories 31, the storage battery 40, and the PCU 50, are disposed under the floor of the passenger compartment R1 in a concentrated fashion. Therefore, these component devices do not reduce the spaces of the passenger compartment R1, the forward compartment R2 and the rearward compartment R3. Furthermore, since the component devices disposed under the passenger compartment R1 have relatively great weights, the center of gravity of the vehicle comes to a low position near the center of the vehicle, thus achieving good running stability of the vehicle.

Furthermore, the hydrogen cylinders 18, the fuel cell battery 30, the storage battery 40 and the PCU 50 are disposed in that order in the direction from the rear to the front of the vehicle, below the floor of the passenger compartment R1. Since the hydrogen cylinders 18 and the fuel cell battery 30 are disposed close to each other, complicated piping for the supply of hydrogen gas from the hydrogen cylinders 18 to the fuel cell battery 30 can be avoided. Since the fuel cell battery 30, the storage battery 40 and the PCU 50 are disposed near to one another, complicated wiring for the electrical connections between these components can be avoided. In addition, the operation of charging the hydrogen cylinders with hydrogen gas can be performed at a rearward site on the vehicle, as is the case with conventional fuel cell equipped vehicles.

Still further, since the fuel cell battery accessories 31 are disposed at the left side of the fuel cell battery 30 and adjacent to the fuel cell battery 30, complicated piping and the like for the connections therebetween can be avoided.

Yet further, since the floor face F of the passenger compartment R1 is generally flat, walkthrough between the front seats and the rear seats in the passenger compartment R1 becomes easy. In addition, when a rear seat is folded, no protrusion appears on the floor face F. In particular, it is preferable that the top surfaces of the component devices disposed under the floor be at the same height, since this arrangement will facilitate a flat design of the floor face F of the passenger compartment R1. To set the top surfaces of the component devices at the same height level, all the component devices may be provided with a fixed height. If the component devices have different heights, base members may be mounted on the body frame 20 so as to equalize the height levels of the top surfaces of the component devices.

The component devices under the floor of the passenger compartment R1 are disposed on top of the generally flat central portion 20a of the body frame 20 between the front wheels FW and the rear wheels RW. Therefore, the embodiment comparatively facilitates the mounting of the component devices. For example, in Japanese Patent Application Laid-open No. 2001-268720, various component devices are first mounted on a tray, and then the tray is connected firmly to a vehicle body. Such a tray is not needed in this embodiment.

The gas pipe 19 connecting the hydrogen cylinders 18 and the mass flow controller 32, and the cooling water circulation path 38 connecting the fuel cell battery 30 and the radiator 39 are laid in a left-side portion of the vehicle in a concentrated fashion. The electric cables 55 to 58 connecting the PCU 50 to the wheels-driving electric motors 14, 16, the fuel cell battery 30 and the storage battery 40 are laid in a right-side portion of the vehicle in a concentrated fashion. This arrangement of the embodiment is favorable for maintenance operations and the like.

It should be apparent that the invention is not restricted by the foregoing embodiment, but that the invention may be carried out in various other manners within the scope of the invention.

For example, although in the foregoing embodiment, the hydrogen cylinders 18, the fuel cell battery 30, the storage battery 40 and the PCU 50 are arranged under the floor of the passenger compartment R1 in that written order in the direction from the rear to the front of the vehicle, it is also possible to arrange the component devices under the floor of the passenger compartment R1 in the order of the hydrogen cylinders 18, the fuel cell battery 30, the PCU 50 and the storage battery 40 in the direction from the rear to the front of the vehicle. This arrangement also achieves substantially the same advantages as the foregoing embodiment achieves. The component devices may also be arranged in the order of the hydrogen cylinders 18, the fuel cell battery 30, the storage battery 40 and the PCU 50 in the direction from the front to the rear of the vehicle, or in the order of the hydrogen cylinders 18, the fuel cell battery 30, the PCU 50 and the storage battery 40 in the direction from the front to the rear of the vehicle. These arrangements also achieve substantially the same advantages and effects as the foregoing embodiment, except that the operation of charging the hydrogen cylinders 18 with hydrogen gas will be performed at a forward site on the vehicle.

Although in the foregoing embodiment, the component devices under the floor of the passenger compartment R1 are mounted on top of the generally flat central portion 20a of the body frame 20, the space between the two frame rails 21, 22 of the body frame 20 may also be utilized to dispose the component devices. This arrangement allows the thickness of each component device to be increased by an amount corresponding to the height of the body frame 20, is therefore useful if size reduction of the component devices is difficult, in comparison with the embodiment in which the component devices are mounted on top of the body frame 20.

Furthermore, although in the foregoing embodiment, the radiator 39 is disposed in the forward compartment R2, the radiator 39 may instead be disposed on a portion (diagonally rising portion) of the body frame 20 which extends between the central portion 20a and the forward portion 20b, or may be laid between the two frame rails 21, 22 of the body frame 20. These arrangements increase the space of the forward compartment R2. In these arrangements, a hood or the like may be provided so that the radiator 39 efficiently receives airflow as the fuel cell equipped vehicle 10 runs.

Still further, although in the foregoing embodiment, the fuel cell equipped vehicle 10 is a four-wheel drive vehicle equipped with the front wheels-driving electric motor 14 and the rear wheels-driving electric motor 16, the vehicle may be equipped with only one of the motors 14, 16. The electric motors for driving wheels may be in-wheel motors.

Furthermore, although the foregoing embodiment adopts the hydrogen cylinders 18 as a fuel gas tank, it is also possible to adopt a tank that employs a hydrogen storage alloy that stores hydrogen at or below a predetermined hydrogen storage temperature and releases hydrogen gas above the hydrogen storage temperature.

Yet further, although in the foregoing embodiment, both the fuel cell battery 30 and the storage battery 40 can be used as power sources to drive the two electric motors 14, 16 (including, in terms of control, the case where both the fuel cell battery 30 and the storage battery 40 are used to drive the motors 14, 16, and the case where only one of the fuel cell battery 30 and the storage battery 40 is used to drive the motors 14, 16), it is also possible to adopt a construction in which only one of the fuel cell battery 30 and the storage battery 40 can be used as a power source to drive the electric motors 14, 16, for example, a construction in which one of the fuel cell battery 30 and the storage battery 40 is used as a power source to drive the electric motors 14, 16, and the other one of the batteries is used as a power source for other devices (e.g., accessories). It is also possible to adopt a construction in which a power source other than the batteries 30, 40 is provided for driving the electric motors 14, 16, and one or both of the batteries 30, 40 assist the power source. Thus, it is appropriate that at least one of the fuel cell battery 30 and the storage battery 40 be usable as a power source for the electric motors 14, 16.

In a fuel cell equipped vehicle 10, hydrogen cylinders 18 storing hydrogen gas to be supplied to a fuel cell battery 30, a fuel cell 30, fuel cell accessories 31, a storage battery 40, and a PCU 50 that controls the supply of electric power from the fuel cell 30 and the storage battery 40 to a front wheels-driving electric motor 14 and a rear wheels-driving electric motor 16 are arranged in that order under a floor of a passenger compartment R1. Therefore, these major component devices do not reduce the spaces of a passenger compartment R1, a forward compartment R2, and a rearward compartment R3. Since the component devices disposed under the floor of the passenger compartment R1 have relatively great weights, the center of gravity of the vehicle comes to a low position in a central portion of the vehicle, thus achieving good running stability of the vehicle.

1-12. (canceled)

13. A fuel cell equipped vehicle comprising:
a fuel cell that generates electric power through a reaction between a fuel gas and an oxidizing gas;
a fuel gas tank that stores the fuel gas to be supplied to the fuel cell;
a fuel cell accessory that operates when the fuel cell generates electric power;
a storage battery that stores electric energy; and
an electric power control unit that controls supply of electric power regarding the fuel cell and the storage battery, wherein the fuel cell, the fuel gas tank, the fuel cell accessory, the storage battery, and the electric power control unit are disposed below a floor of a passenger compartment of the vehicle.

14. The fuel cell equipped vehicle according to claim 13, wherein the fuel gas tank, the fuel cell, the storage battery, and the electric power control unit are arranged in that written order in a longitudinal direction relative to the vehicle.

15. The fuel cell equipped vehicle according to claim 13, wherein the fuel gas tank, the fuel cell, the electric power control unit, and the storage battery are arranged in that written order in a longitudinal direction relative to the vehicle.

16. The fuel cell equipped vehicle according to claim 13, wherein the fuel cell accessory is disposed at one or both of a right side and a left side of the fuel cell.

17. The fuel cell equipped vehicle according to claim 13, wherein an upper surface of the fuel cell, an upper surface of the fuel gas tank, an upper surface of the fuel cell accessory, an upper surface of the storage battery, and an upper surface of the electric power control unit are at substantially equal heights.

18. The fuel cell equipped vehicle according to claim 13, wherein the fuel cell, the fuel gas tank, the fuel cell accessory, the storage battery, and the electric power control unit are mounted on an upper portion of a generally flat portion of a body frame of the vehicle which extends between a front wheel and a rear wheel.

19. The fuel cell equipped vehicle according to claim 13, wherein the fuel cell, the fuel gas tank, the fuel cell accessory, the storage battery, and the electric power control unit are disposed in a space formed between a right-side frame of a body frame of the vehicle which extends in a longitudinal direction relative to the vehicle in a right-side portion of the vehicle and a left-side frame of the body frame which extends in the longitudinal direction relative to the vehicle in a left-side portion of the vehicle.

20. The fuel cell equipped vehicle according to claim 13, further comprising a radiator that radiates heat from a cooling water for cooling the fuel cell, and that is disposed on a portion of a body frame of the vehicle which extends between a central portion of the body frame and a forward portion of the body frame.

21. The fuel cell equipped vehicle according to claim 20, wherein the radiator is disposed so as to lie between two frame rails of the body frame.

22. The fuel cell equipped vehicle according to claim 13, further comprising at least one of a front wheel-driving electric motor and a rear wheel-driving electric motor, wherein the electric power control unit controls supply of electric power from the fuel cell and the storage battery to the at least one of the front wheel-driving electric motor and the rear wheel-driving electric motor.

23. The fuel cell equipped vehicle according to claim 13, further comprising:
a gas pipe that supplies the fuel gas from the fuel gas tank to the fuel cell; and
an electrical wire that conducts electric power from the fuel cell and the storage battery to the electric power control unit, wherein the gas pipe is provided in one of a right-side portion and a left-side portion of the vehicle, and the electrical wire is provided in another one of the right-side portion and the left-side portion of the vehicle.

24. The fuel cell equipped vehicle according to claim 23, further comprising a coolant circulator device that circulates a coolant for cooling the fuel cell, wherein a coolant circulation path of the coolant circulator device and the gas pipe are provided in one of the right-side portion and the left-side portion of the vehicle, and the electrical wire is provided in another one of the right-side portion and the left-side portion of the vehicle.
